(19) United States
(12) Patent Application Publication
(10) Pub. No.: US 2019/0165867 A1
(43) Pub. Date: May 30, 2019

(54) OPTICAL RECEIVER AND CONTROL METHOD OF THE OPTICAL RECEIVER

(71) Applicant: ELECTRONICS AND TELECOMMUNICATIONS RESEARCH INSTITUTE, Daejeon (KR)

(72) Inventors: Sun Hyok CHANG, Daejeon (KR); Hun Sik KANG, Daejeon (KR); Joon Ki LEE, Daejeon (KR); Jie Hyun LEE, Daejeon (KR)

(21) Appl. No.: 16/014,166

(22) Filed: Jun. 21, 2018

(30) Foreign Application Priority Data
Nov. 24, 2017 (KR) 10-2017-0158140

(51) Int. Cl. H04B 10/61; H04B 10/40; H04B 10/524; H04B 10/2507; H04B 10/27; H04B 10/516; H04B 10/564; H04L 1/00

(52) U.S. Cl. CPC H04B 10/6161; H04B 10/40; H04B 10/524; H04L 1/0054; H04B 10/27; H04B 10/5161; H04B 10/564; H04B 10/2507

(57) ABSTRACT

An optical receiver and a method of controlling the optical receiver. The method may include setting, by a controller, a dispersion value of a dispersion compensator to compensate for a dispersion of an optical signal received through an optical fiber, compensating, by the dispersion compensator, for the dispersion of the optical signal based on the set dispersion value, performing, by the controller, an error correction with respect to the optical signal of which the dispersion is compensated and verifying a number of bit errors, and resetting, by the controller, the dispersion value of the dispersion compensator based on the verified number of bit errors.

### CROSS-REFERENCE TO RELATED APPLICATION

This application claims the priority benefit of Korean Patent Application No. 10-2017-0158140, filed Nov. 24, 2017, in the Korean Intellectual Property Office, the disclosure of which is incorporated herein by reference for all purposes.

### BACKGROUND

### 1. Field

One or more example embodiments relate to an optical receiver and a method of controlling the optical receiver, and more particularly, to an apparatus and method for optimizing a performance of an optical receiver using a direct detection scheme and a high-order modulation/demodulation signal.

### 2. Description of Related Art

An optical transceiver is a core component of an optical communication system. The optical transceiver performs an optical transmission function of converting an electrical signal to an optical signal and transmitting the optical signal and performs an optical reception function of converting the transmitted optical signal to the electrical signal. The optical transceiver used for a short-range network or a data center has a limited transmission distance of 10 km or less, and employs, for example, a direct detection scheme and an on-off keying (OOK) scheme or a pulse amplitude modulation (PAM) scheme. That is, a technology for low cost, compact size, and low power is used by a characteristic of an applied network.

The optical transceiver applied to a large metro/backbone optical network has a transmission distance of hundreds of kilometers or more, and employs a coherent detection scheme and a high-order modulation/demodulation scheme, such as a quadrature phase shift keying (QPSK) scheme and a quadrature amplitude modulation (QAM) scheme.

A demand for optical transmission for a metro access network is expected to rapidly increase in the future as traffic between subscribers to wired/wireless communication and the data centers increases due to a hyper-connected service, such as a fifth-generation (5G) wireless system, big data, and the Internet of things (IoT). The metro access network has a transmission distance of 80 km or less. A technology has been developed to extend transmission distance up to 80 km, in addition to the technology for low cost and compact size applied to short-range networks or data centers. In order to achieve this transmission distance, there is a need for a technology that compensates for dispersion of an optical signal received through an optical fiber and a need for a digital signal processing technology for equalizing and restoring a received signal.

### SUMMARY

At least one example embodiment provides an optical receiver and a method of controlling the optical receiver.

At least one example embodiment also provides an apparatus and method that may optimize a performance of an optical receiver by performing an error correction and controlling a dispersion compensator and an optical amplifier using obtainable bit error information.

According to an aspect of at least one example embodiment, there is provided a method of controlling an optical receiver including setting, by a controller, a dispersion value of a dispersion compensator to compensate for a dispersion of an optical signal received through an optical fiber; compensating, by the dispersion compensator, for the dispersion of the optical signal based on the set dispersion value; performing, by the controller, an error correction with respect to the optical signal of which the dispersion is compensated and verifying a number of bit errors; and resetting, by the controller, the dispersion value of the dispersion compensator based on the verified number of bit errors.

The resetting of the dispersion value may include verifying, by the controller, a number of bit errors by performing the error correction with respect to the optical signal of which the dispersion is compensated based on the reset dispersion value, comparing the verified number of bit errors corresponding to the set dispersion value and the verified number of bit errors corresponding to the reset dispersion value, and resetting the dispersion value of the dispersion compensator to decrease the number of bit errors.

The resetting of the dispersion value may include resetting the dispersion value of the dispersion compensator, so that the verified number of bit errors becomes less than or equal to a preset threshold.

The preset threshold may be determined based on a number of bit errors that are processible based on an error correction performance of the controller.

The set dispersion value may be differently set based on a length of an optical fiber connected to the optical receiver.

According to another aspect of at least one example embodiment, there is provided a method of controlling an optical receiver including setting, by a controller, an optical power of an optical signal to be amplified and output through an optical amplifier; amplifying, by the optical amplifier, the optical signal received through an optical fiber based on the set optical power; performing, by the controller, an error correction with respect to the amplified and output optical signal and verifying a number of bit errors; and resetting, by the controller, the optical power of the optical signal to be amplified and output through the optical amplifier based on the verified number of bit errors.

The resetting of the optical power may include verifying, by the controller, a number of bit errors by performing the error correction with respect to the optical signal of which the dispersion is compensated based on the reset dispersion value, comparing the verified number of bit errors corresponding to the set optical power of the optical signal and the verified number of bit errors corresponding to the reset optical power of the optical signal, and resetting the optical power of the optical signal to be amplified and output through the optical amplifier to decrease the number of bit errors.

The resetting of the optical power may include resetting the optical power of the optical signal to be amplified and output through the optical amplifier, so that the verified number of bit errors becomes less than or equal to a preset threshold.

The preset threshold may be determined based on a number of bit errors that are processible based on an error correction performance of the controller.

The set dispersion value may be differently set based on a length of an optical fiber connected to the optical receiver.

According to still another aspect of at least one example embodiment, there is provided an optical receiver including an optical amplifier configured to amplify an optical signal received through an optical fiber; a dispersion compensator configured to compensate for a dispersion of the optical signal output from the optical amplifier; and a controller configured to perform an error correction with respect to the optical signal output from the dispersion compensator and verify a number of bit errors. The controller may be configured to set an optical power of the optical signal to be amplified and output through the optical amplifier and/or a dispersion value of the dispersion compensator based on the verified number of bit errors.

The controller may be configured to verify a number of bit errors by performing the error correction with respect to the optical signal of which the dispersion is compensated based on the reset dispersion value, to compare the verified number of bit errors corresponding to the set dispersion value and the verified number of bit errors corresponding to the reset dispersion value, and to reset the dispersion value of the dispersion compensator to decrease the number of bit errors.

The controller may be configured to reset the dispersion value of the dispersion compensator, so that the verified number of bit errors becomes less than or equal to a preset threshold.

The preset threshold may be determined based on a number of bit errors that are processible based on an error correction performance of the controller.

The set dispersion value may be differently set based on a length of an optical fiber connected to the optical receiver.

The controller may be configured to verify a number of bit errors by performing the error correction with respect to the optical signal of which the dispersion is compensated based on the reset dispersion value, to compare the verified number of bit errors corresponding to the set optical power of the optical signal and the verified number of bit errors corresponding to the reset optical power of the optical signal, and to reset the optical power of the optical signal to be amplified and output through the optical amplifier to decrease the number of bit errors.

The controller may be configured to reset the optical power of the optical signal to be amplified and output through the optical amplifier, so that the verified number of bit errors becomes less than or equal to the preset threshold.

The preset threshold may be determined based on a number of bit errors that are processible based on an error correction performance of the controller.

The set optical power may be differently set based on a length of an optical fiber connected to the optical receiver.

According to some example embodiments, it is possible to optimize a performance of an optical receiver by performing an error correction and controlling a dispersion compensator and an optical amplifier using obtainable bit error information.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a structure of an optical transceiver according to an example embodiment;

FIG. 2 is a diagram illustrating a structure of an optical receiver according to an example embodiment;

FIG. 3 is a graph showing a change in a bit error rate (BER) over a residual dispersion value according to air example embodiment;

FIG. 4 is a flowchart illustrating an example of a method of controlling an optical receiver by optimizing a performance of the optical receiver according to an example embodiment;

FIG. 5 is a graph showing a change in a BER over an optical power of an optical signal input to a photodiode according to an example embodiment; and

FIG. 6 is a flowchart illustrating another example of a method of controlling an optical receiver by optimizing a performance of the optical receiver according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, example embodiments are described with reference to the accompanying drawings.

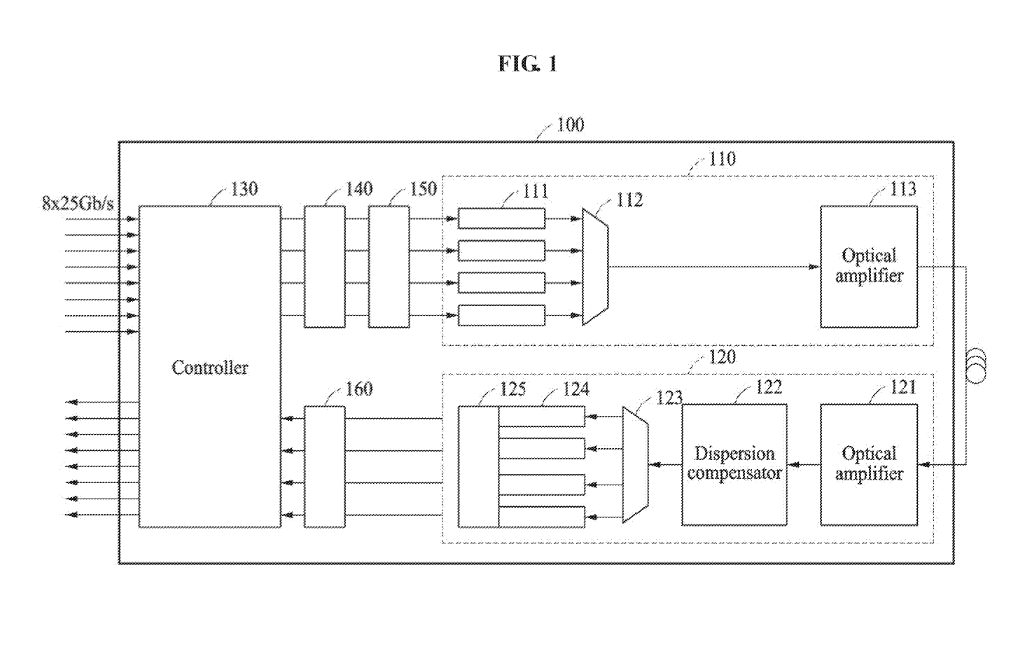

FIG. 1 is a diagram illustrating a structure of an optical transceiver according to an example embodiment.

A structure of an optical transceiver 100 applicable to a metro access network will be described with reference to FIG. 1. Referring to FIG. 1, the optical transceiver 130 that processes an optical signal transmitted and received from the optical transmitter 110 and the optical receiver 120. For example, a total transmission capacity of the optical transceiver 100 is set as 200 gigabits per second (Gb/s). The structure of the optical transceiver 100 may be partially modified based on the total transmission capacity.

Eight electrical signals having a transmission rate of 25 Gb/s may be received by the optical transceiver 100 from an external host. Once the eight electrical signals are received using an interface function, the controller 130 of the optical transceiver 100 may perform an encoding for an error correction with respect to the received eight electrical signals. Here, for example, the cot 130 may perform the encoding using a forward error correction (FEC) technology with respect to the received electrical signals.

The controller 130 may generate a pulse amplitude modulation (PAM) signal that is a high-order modulation/demodulation signal by performing a digital signal processing with respect to the encoded electrical signals. Here, the controller 130 may generate a PAM-4 electrical signal having a transmission rate of 50 Gb/s (hereinafter, also referred to as a 50 Gb/s PAM-4 electrical signal) by combining two electrical signals each having a transmission rate of 25 Gb/s and received using the interface function. That is, the controller 130 may generate a total of four PAM-4 electrical signals each having the transmission rate of 50 Gb/s based on the total transmission capacity of 200 Gb/s of the transceiver 100. The generated four 50 Gb/s PAM-4 electrical signals may be converted to analog signals and output by a digital-to-analog converter (DAC) 140. The four 50 Gb/s PAM-4 electrical signals that are converted to the analog signals may be transmitted to a 4-channel linear driver 150 and individually amplified. The amplified four 50 Gb/s PAM-4 electrical signals may be received by the optical transmitter 110.

Here, the optical transmitter 110 may include a laser diode 111, an optical multiplexer (MUX) 112, and an optical amplifier 113. The optical transmitter 110 may generate 50 Gb/s PAM-4 optical signals by performing an optical modulation of the received 50 Gb/s PAM-4 electrical signals using the laser diode 111. Here, the optical transmitter 110 may use the laser diode 111, such as an electro-absorption modulated laser (EML) or a directly modulated laser (DML), or may use an external modulator, such as a Mach-Zehnder modulator (MZM). The modulated four 50 Gb/s PAM-4 optical signals may have different wavelengths, respectively, and may be combined into a single optical signal and output using the optical MUX 112. The single optical signal output from the optical MUX 112 may be amplified by the cal amplifier 113 and transmitted through an optical fiber. Here, the optical amplifier 113 may be not used based on output power of the optical transmitter 110. A number of wavelength channels may change based on the total transmission capacity.

The optical signal transmitted through the optical transmitter 110 of the optical transceiver 100 may be received by the optical receiver 120 through the optical fiber. The optical receiver 120 may include an optical amplifier 121, a dispersion compensator 122, an optical demultiplexer (DMUX) 123, a photodiode 124, and a transimpedance amplifier (TIA) 125.

The optical amplifier 121 may amplify the optical signal received through the optical fiber and output the optical signal, and may compensate for an optical loss occurring while the optical signal is transmitted through the optical fiber. The loss-compensated optical signal may be transmitted to the dispersion compensator 122. A dispersion occurring while the optical signal is transmitted through the optical fiber may be compensated for. The dispersion-compensated optical signal may be demultiplexed to four optical signals having different wavelengths, respectively, using the optical DMUX 123. Each of the demultiplexed optical signals may be input to the corresponding photodiode 124 and converted to an electrical signal. The electrical signals may be amplified by the TIA 125.

The electrical signals amplified by the TIA 125 may be converted to digital signals by an analog-to-digital converter (ADC) 160. The controller 130 may restore the electrical signals converted to the digital signals and received using a function of an equalizer, such as a decision feedback equalizer (DFE), a feedforward equalizer (FFE), and a maximum likelihood sequence equalizer (MLSE). The controller 130 may decode the restored electrical signals and perform the error correction. Here, for example, the controller 130 may decode the restored electrical signals and perform the error correction with respect to the restored electrical signals using the FEC technology. The controller 130 may transmit the electrical signals with respect to which the error correction is performed to the external host using the interface function.

To optimize a transmission and reception performance of the optical transceiver 100, a number of bit errors needs to be minimized, and the minimized number of bit errors needs to be less than or equal to a threshold that is processible based on an error correction performance of the controller 130. When the number of bit errors is less than or equal to the threshold processible based on the error correction performance of the controller 130, a bit error rate (BER) may be maintained to be 1×10⁻¹⁵ or less by performing the error correction with respect to all the bit errors of transmitted and received optical signals using the controller 130.

A length of the optical fiber may change based on a state of an optical line. The dispersion value and the optical loss occurring while the optical signal is transmitted. Amounts of the dispersion and the optical loss may change based on the length of the optical fiber. Therefore, to optimize the transmission and reception performance by minimizing the number of bit errors, the dispersion and the optical loss need to be effectively compensated for.

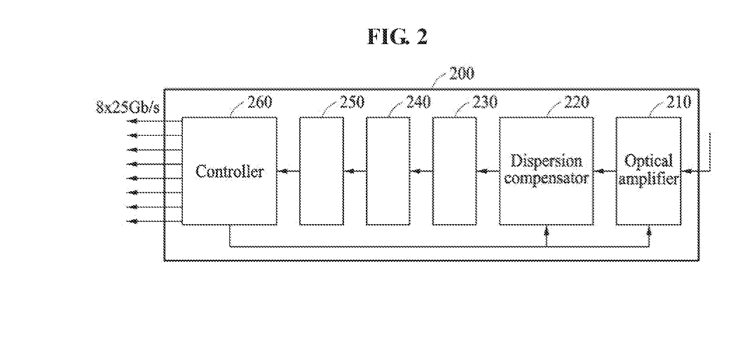

FIG. 2 is a diagram illustrating a structure of an optical receiver according to an example embodiment.

Example embodiments provide a control method and apparatus for optimizing a performance of an optical receiver in an optical transceiver, for example, the optical transceiver 100 of FIG. 1, using a direct detection scheme to apply to a metro access network having a relatively long transmission distance. To increase a transmission rate and simultaneously apply a technology for low cost and compact size, a PAM scheme that is a high-order modulation/demodulation scheme may be applied. Referring again to FIG. 1, the dispersion compensator 122 using an optical dispersion compensation scheme is used to extend the transmission distance. Also, the optical amplifier 121 is used to compensate for an optical loss in an optical fiber. An output of the photodiode 124 of the optical receiver 120 may be restored through digital signal processing and an error correction may be performed using the controller 130. The optical receiver 120 may verify a transmission/reception performance by verifying a bit error occurring in a signal received through the controller 130. An optimized reception performance may be obtained by controlling a dispersion value of the dispersion compensator 122 and/or an optical power of an optical signal to be amplified and output through the optical amplifier 121 using the optimized reception performance as a feedback signal.

Referring to FIG. 2, an optical receiver 200 may include an optical amplifier 210, a dispersion compensator 220, a photodiode 230, a TIA 240, an ADC 250, and a controller 260.

The optical amplifier 210 of the optical receiver 200 may amplify a received optical signal and output the optical signal to the dispersion compensator 220. Here, the optical amplifier 210 may compensate for an optical loss occurring while the received optical signal is transmitted through an optical fiber. The dispersion compensator 220 may compensate for a dispersion occurring while the received optical signal is transmitted through the optical fiber. The PD 230 may receive the optical signal of which the dispersion is compensated and convert the optical signal to an electrical signal. The TIA 240 may amplify the converted electrical signal and output the electrical signal to the ADC 250. The ADC 250 may convert the received electrical signal to a digital signal.

The controller 260 may perform an equalization and a restoration with respect to the electrical signal converted to the digital signal and perform an error correction with respect to the restored signal. The controller 260 may verify information about, for example, a location at which a bit error occurs, a number of bit errors, and the like through the error correction with respect to the restored signal. Here, the controller 260 may obtain an optimized reception performance with respect to the optical receiver 200 by resetting an optical power of the optical signal to be output through the optical amplifier 210 and a dispersion value of the dispersion compensator 220 using the verified number of bit errors.

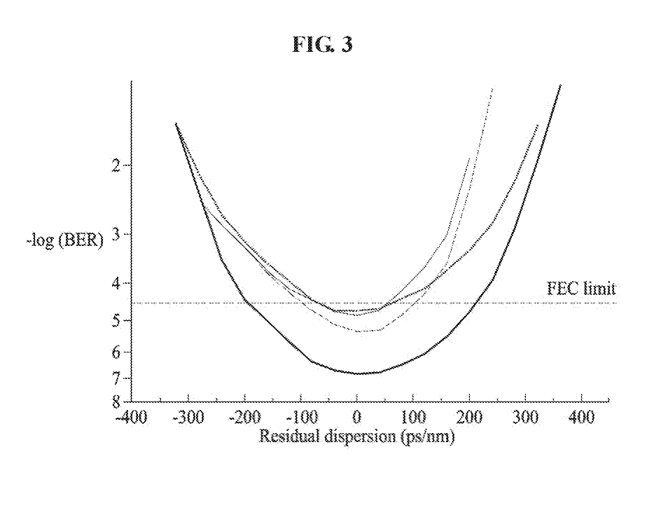

FIG. 3 is a graph showing a change in a bit error rate (BER) over a residual dispersion value according to an example embodiment.

Referring to FIG. 3, it can be verified that a HER of a received optical signal changes based on a change in a dispersion value set in the dispersion compensator 220. Although, each of curves shown in the graph is obtained under a different condition, the BER rapidly increases according to an increase in the residual dispersion in which a dispersion of an optical fiber is not compensated. To optimize a performance of the optical receiver 200, the residual dispersion needs to be minimized within an accuracy of ±50 picoseconds per nanometer (ps/nm). Thus, the performance of the optical receiver 200 may be optimized by resetting the dispersion value of the dispersion compensator 220, so that the controller 260 of the receiver 200 may minimize a verified number of bit errors.

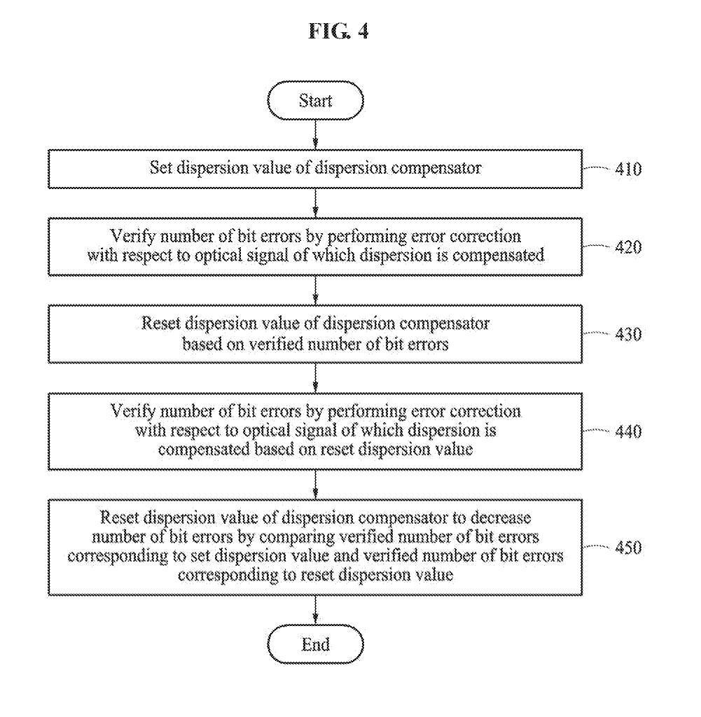

FIG. 4 is a flowchart illustrating an example of a method of controlling an optical receiver by optimizing and a performance of the optical receiver according to an example embodiment.

In operation 410, the controller 260 may set a dispersion value of the dispersion compensator 220. Here, when the controller 260 initially sets the dispersion value, the controller 260 may set the dispersion value based on a length of an optical fiber used for optical transmission. In general, a single fiber has a dispersion of ˜17 ps/nm/km in a wavelength band of 1550 nm. Thus, if the optical fiber used for optical transmission has a length of 80 km, the controller 260 may set a dispersion value of 1360 ps/nm to the dispersion compensator 220. An optical signal of which the dispersion is compensated by the dispersion compensator 220 may be received by the controller 260.

In operation 420, the controller 260 may perform an error correction with respect to signal of which the dispersion is compensated and verify a number of bit errors.

In operation 430, the controller 260 may reset the dispersion value of the dispersion compensator 220 based on the verified number of bit errors. Here, the controller 260 may reset the dispersion value of the dispersion compensator 220 so that a difference of +50 ps/nm or −50 ps/nm may be present between the previously set dispersion u and the reset dispersion value. The optical signal of which the dispersion is compensated by the dispersion compensator 220 having the reset dispersion value may be receive by the controller 260.

In operation 440, the controller 260 may verify a number of bit errors by performing an error correction with respect to the optical signal of which the dispersion is compensated based on the reset dispersion value.

In operation 450, the controller 260 may reset the dispersion value of the dispersion compensator 220 to decrease the number of bit errors by comparing the number of bit errors verified in operation 420 and the number of bit errors verified in operation 440. Here, the controller 260 may repetitively perform operation 430 of resetting the dispersion value until the number of bit errors is less than or equal to a preset threshold. The preset threshold may be determined based on a number of bit errors that are processible based on an error correction performance of the controller 260. Also, an optimal dispersion value may be obtained by gradually reducing an amount of change in dispersion value setting during a repetitively performing procedure.

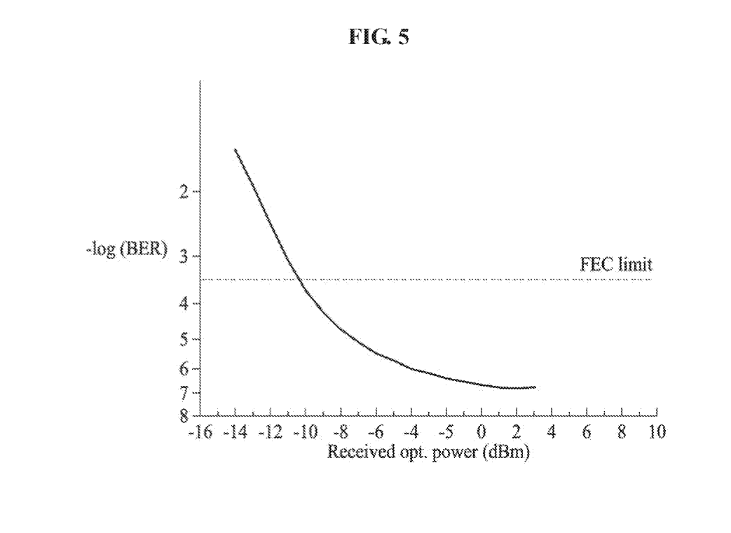

FIG. 5 is a graph showing a change in a BER over an optical power of an optical signal input to a photodiode according to an example embodiment.

Referring to FIG. 5, it can be verified that a BER changes based on a change in an optical power of an optical signal amplified and output through the optical amplifier 210 and then input to the PD 230. From the graph, it can be known that the BER decreases according to an increase in the optical power of the optical signal input to the PD 230. When significantly great optical power of the optical signal is input to the PD 230, an input of the TIA 240 increases and an overload state may occur. Alternatively, a nonlinearity may increase, which may lead to increasing the BER again. Thus, to optimize a performance of the optical receiver 200, the optical power of the optical signal that is input to the PD 230 may need to be appropriately set. The controller 260 of the optical receiver 200 may optimize the performance of the optical receiver 200 by adjusting the optical power of the optical signal to be amplified and output through the optical amplifier 210 and resetting the optical power to minimize a number of bit errors. Also, an optimal optical power may be obtained by gradually reducing a variation in setting the optical power during a repetitively performing procedure.

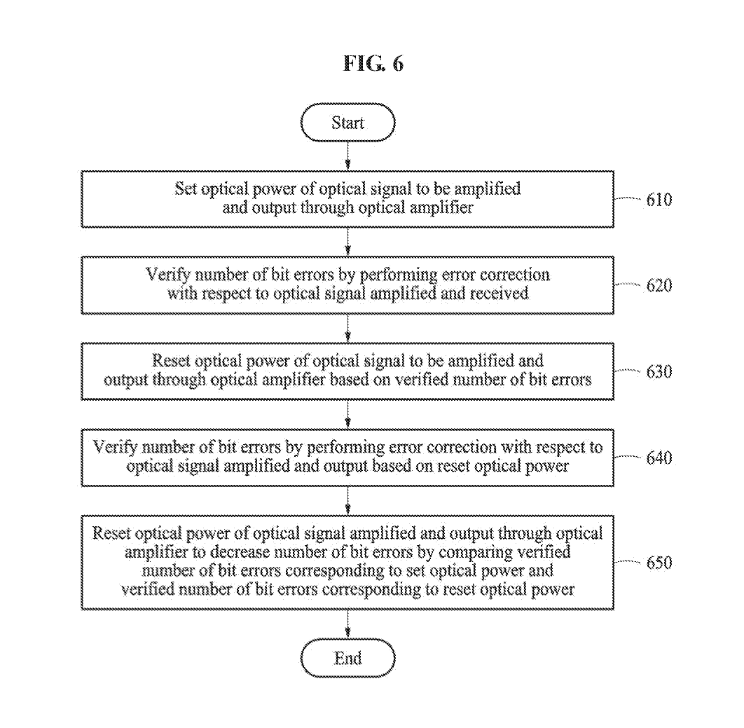

FIG. 6 is a flowchart illustrating another example of a method of controlling an optical receiver by optimizing a performance of the optical receiver according to an example embodiment.

In operation 610, the controller 260 may set an optical power of an optical signal to be amplified and output through the optical amplifier 210. Here, when the controller 260 initially sets the optical power, the controller 260 may set the optical power based on a length of an optical fiber connected to the optical receiver 200. The optical signal that is amplified and output through the optical amplifier 210 may be received by the controller 260.

In operation 620, the controller 260 may verify a number of bit errors by performing an error correction with respect to the optical signal that is amplified and received.

In operation 630, the controller 260 may reset the optical power of the optical signal to be amplified and output through the optical amplifier 210 based on the verified number of bit errors. Here, the controller 260 may reset the optical power of the optical amplifier 210 so that a difference of +0.5 dBm or −0.5 dBm may be between the previously set optical power and the optical power. The optical signal that is amplified and output by the optical amplifier 210 having the reset optical power may be received by the controller 260.

In operation 640, the controller 260 may verify a number of bit errors by performing the error correction with respect to the optical signal that is amplified and output based on the reset optical power.

In operation 650, the controller 260 may reset the optical power of the optical signal that is amplified and output through the optical amplifier 210 to decrease the number of bit errors by comparing the number of bit errors verified in operation 620 and the number of bit errors verified in operation 640. Here, the controller 260 may repetitively perform operation 630 of resetting the optical power until the number of bit errors is less than or equal to a preset threshold. The preset threshold may be determined based on the number of bit errors that are processible based on an error correction performance of the controller 260.

According to example embodiments, there may be provided a method of optimizing a performance of an optical receiver by resetting, based on a verified number of bit errors, a dispersion value of a dispersion compensator and an optical power of an optical amplifier that are included in the optical receiver. Thus, it is possible to optimize the performance of the optical receiver by individually or simultaneously resetting the dispersion value of the dispersion compensator and the optical power of the optical amplifier.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The example embodiments described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include plurality of processing elements and plurality of types of processing elements. For example, a processing device may include plurality of processors or a processor and a controller. In addition, different processing configurations are possible, such parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc, and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. (canceled)

2. (canceled)

3. (canceled)

4. (canceled)

5. (canceled)

6. A method of controlling an optical receiver, the method comprising:
setting, by a controller, an optical power of an optical signal which is to be amplified and output through an optical amplifier;
amplifying, by the optical amplifier, the optical signal, which is received through an optical fiber, based on the set optical power;
performing, by the controller, an error correction with respect to the amplified optical signal, and verifying, by the controller, a number of bit errors; and
resetting, by the controller, the optical power of the optical signal, which is to be amplified and output through the optical amplifier, based on the verified number of bit errors.

7. The method of claim 6, wherein the resetting, of the optical power comprises:
verifying, by the controller, a number of bit errors by performing the error correction with respect to the optical signal which is amplified based on the reset optical power,
comparing, by the controller, the verified number of bit errors corresponding to the set, optical power of the optical signal with the verified number of bit errors corresponding to the reset optical power of the optical signal, and
resetting, by the optical power of the optical signal, which is to be amplified and output through the optical amplifier, to decrease the number of bit errors.

8. The method of claim 6, wherein the resetting of the optical power comprises resetting the optical power of the optical signal, which is to be amplified and output through the optical amplifier, so that the verified number of bit errors becomes a preset threshold or less.

9. The method of claim 8, wherein the preset threshold is determined based on a number of bit errors that are processed based on an error correction performance of the controller.

10. The method of claim 6, wherein the set optical power is differently set based on a length of the optical fiber connected to the optical receiver.

11. An optical receiver comprising:
an optical amplifier configured to amplify an optical signal received through an optical fiber, based on an optical power of the optical signal which is set by a controller;
a dispersion compensator configured to compensate for a dispersion of the optical signal output from the optical amplifier, based on a dispersion value of the dispersion compensator which is set by the controller; and
the controller configured to perform an error correction with respect to the optical signal output from the dispersion compensator and verify a number of bit errors,
wherein the controller is further configured to reset the optical power of the optical signal, which is to be amplified and output through the optical amplifier, and/or the dispersion value of the dispersion compensator, based on the verified number of bit errors.

12. The optical receiver of claim 11, wherein the controller is configured to:
verify a number of bit errors by performing the error correction with respect to the optical signal of which the dispersion is compensated based on the reset dispersion value,
compare the verified number of bit errors corresponding to the set dispersion value with the verified number of bit errors corresponding to the reset dispersion value, and
reset the dispersion value of the dispersion compensator to decrease the number of bit errors.

13. The optical receiver of claim 11, wherein the controller is configured to reset the dispersion value of the dispersion compensator so that the verified number of bit errors becomes a preset threshold or less.

14. The optical receiver of claim 13, wherein the preset threshold is determined based on a number of bit errors that are processed based on an error correction performance of the controller.

15. The optical receiver of claim 11, wherein the set dispersion value is differently set based on a length of the optical fiber connected to the optical receiver.

16. The optical receiver of claim 11, wherein the controller is configured to:
verify a number of bit errors by performing the error correction with respect to the optical signal which is amplified based on the reset optical power,
compare the verified number of bit errors corresponding to the set optical power of the optical signal with the verified number of bit errors corresponding to the reset optical power of the optical signal, and
reset the optical power of the optical signal, which is to be amplified and output through the optical amplifier, to decrease the number of bit errors.

17. The optical receiver of claim 11, wherein the controller is configured to reset the optical power of the optical signal, which is to be amplified and output through the optical amplifier, so that the verified number of bit errors becomes a preset threshold or less.

18. The optical receiver of claim 17, wherein the preset threshold is determined based on a number of bit errors that are processed based on an error correction performance of the controller.

19. The optical receiver of claim 11, wherein the set optical power is differently set based on a length of the optical fiber connected to the optical receiver.
